(19) United States
(12) Patent Application Publication
(10) Pub. No.: US 2020/0325916 A1
(43) Pub. Date: Oct. 15, 2020

(54) DRIVE-TORQUE AMPLIFIER FOR A MOVING SHAFT

(71) Applicants: José Felipe ZOLLNER VALDETTARIO, Lima (PE); Augusto ZOLLNER DIANDERA, Lima (PE)

(72) Inventors: José Felipe ZOLLNER VALDETTARIO, Lima (PE); Augusto ZOLLNER DIANDERA, Lima (PE)

(21) Appl. No.: 16/620,563

(22) PCT Filed: Jun. 8, 2018
(86) PCT No.: PCT/PE2018/000013

§ 371 Date: Dec. 9, 2019

(30) Foreign Application Priority Data
Jun. 9, 2017 (PE) 0009802017/DIN

(51) Int. Cl. F15B 7/02; F01B 7/04; F15B 7/00; F15B 7/08; F16H 21/18; F16H 25/14; F16H 39/20

(52) U.S. Cl. CPC F15B 7/02; F01B 7/04; F15B 7/005; F16H 39/20; F15B 7/08; F16H 21/18; F16H 25/14; F15B 7/008

(57) ABSTRACT

The invention relates to a machine that amplifies the drive torque of a moving shaft, which is formed by at least one pair of identical units facing a central shaft, each unit being formed by at least one mechanical actuator (cam), a hydraulic actuator (amplified linear force that provides the application of Pascal's law) and a mechanism comprising a piston, connecting rod and crankshaft. For mechanical considerations, the machine is a two-stroke engine (compression and intake) having at least two opposite horizontal pistons, that is, a 180° V engine.

### TECHNICAL FIELD

This invention describes a device in the mechanical field of machines driven by pressurised hydraulic fluid, which move components from one position to another.

### PRIOR ART

There are currently many methods for improving the torque produced by motors, but for the case of amplifying the torque of an output shaft of a motor, that is, rotating shafts, the patent that is most similar to the invention proposed is the patent with the publication code CN201903893 (u), which was granted to the Chinese citizen Wang Yuxi in 2014.

The motor in question is a hydraulic motor with input and output fluid hoses, composed of a central block of sections A and B, cams A and B, return springs A and B, and a vertical shaft terminating at its lower end in a bevel gear A, of a transverse movement mechanism which contains the hoses, of an power output mechanism composed of pistons, connecting rods and a horizontal crankshaft which is attached to the vertical shaft at its far right through a bevel gear B, and of a fluid tank.

The technique used is to inject, through the fluid input and output hoses, and through its branched fittings, pressure into the fluid which enters the cylinders and pushes the pistons and these cylinders by means of its connecting rods to the horizontal crankshaft, generating increased torque on the crankshaft.

However, the hydraulic motor of the aforementioned patent, by using two shafts, one of which is a power input shaft and the other of which is a power output shaft, and by having various moving parts (fluid input and output hoses, branch fittings, cams, return springs, transverse mechanism, vertical shaft, pistons, crankshaft, gears), is a machine that is difficult to maintain, foreseeably noisy, and many of its parts are subject to continuous wear. Furthermore, by not having a single power shaft, it can only be placed at the outlet of a machine in order to increase the torque of said machine, but the hydraulic motor of the patent cannot be attached to other device(s) from the same patent to achieve higher levels of torque, that is to say, it cannot be used when attached to a machine.

### DETAILED DESCRIPTION OF THE PROPOSED INVENTION

As a solution to the disadvantages and problems mentioned above, this invention was developed, the inventive step of which is the use of the mechanical advantage which involves the application of Pascal's Law, in this case, for rotary movement.

The device is a machine that amplifies the torque of a rotating shaft due to the effect of energy in the form of rotary movement that it receives from the outside, through the joint work of at least one mechanical actuator (cam), one hydraulic actuator (amplified linear force that provides the application of Pascal's Law) and one piston-connecting rod-crankshaft mechanism); it is by mechanical considerations, a two-stroke motor (compression and recharge), of at least one pair of horizontally opposed pistons, that is, an 180-degree V-motor, which is composed of at least one pair of identical units on either side of a crankshaft with at least one central elbow for connecting rods, with at least one eccentric circular cam fixed to the crankshaft, each cam with a portion of its perimetral area forming tangency with the surface of the crankshaft and of at least two bearings for its rolling movement, which receives both external energy in the form of rotary movement as well as torque that the device itself amplifies, each unit being composed of an outer case that encases each unit, of a motor block, which is a solid part that is fixed to the inner side of the outer case, containing orifices that form the cylinders in which the plungers operate, of an inner case that is a cylinder that is fixed to the inner side of the motor block, of a cylinder head flange, which is a part that serves to reinforce the outer case, which is fixed to the outer side of the outer case at the furthest end from the crankshaft, of a mating flange, which is a part that serves to reinforce the outer case, which is fixed to the outer side of the outer case at the end nearest to the crankshaft, of a cylinder head, which is a cap that is fixed to the cylinder head flange, of a compression chamber, which is a space that forms between the cylinder head flange, the end of the outer case near to it, the end of the inner case near to it and by the upper surface of the Piston, and which is filled with hydraulic fluid, of a plunger that is a vessel with a cap and base whose cap is fixed to the inner section of the wall and contains a series of mini plungers, to pressurise the fluid in the compression chamber and openings so that the fluid from the plunger enters/leaves the plunger to serve its role of sealing, lubricating and cooling, and whose base is fixed to the inner section of the wall, and fixed at its outer end are two studs, diametrically opposed, where each of the roller followers are located, which will be used to linearly displace the plunger due to the drive of the cams, the plungers of each unit being fixed to each other by means of rods fastened at the section furthest from the cylinder head of both plungers, each plunger moving in the space between the inside of the outer case and the outside of the inner case, making contact with the walls by means of the pressure and oil rings, of a piston that is a cylinder that moves within the inner case and that is connected via its connecting rod to the crankshaft in order to convert the linear force of the piston into amplified torque on the crankshaft, and making contact with the inner case by means of the pressure and oil rings.

We will describe the functioning of the invention citing what happens in the unit located on the front left when receiving external energy in the crankshaft in the form of rotary movement. When the crankshaft receives movements, its cams push the roller followers with linear force, and these in turn push the plunger, whose cap approaches the motor block, introducing its mini plungers into the cylinders thereof, thereby pressurising the fluid in the compression chamber. This pressure causes a linear force amplified by the action of Pascal's law, to push the piston, moving it away from its cylinder head so that, through its connecting rod, it transmits torque to the crankshaft. While the cap of the plunger approaches the motor block, the hydraulic fluid contained between the cap, the motor block, the outer case and inner case, due to pressure, starts entering the plunger vessel through the openings, after fulfilling its role of sealing the mini plungers, cooling the inner case and lubricating the outer case.

Every half-turn that the crankshaft receives from the outside becomes a half-turn with amplified torque on the crankshaft. Thus, the left-hand unit, with one half-turn from the outside, completes its compression time. While this is happening, the right-hand unit completes its recharge time, since, being fixed to one other, the plungers of both units work as a desmodromic system, while the plunger of the left-hand unit approaches its cylinder head, the plunger of the right-hand unit moves away from its cylinder head, that is, while the left-hand unit completes its compression time, the right-hand unit completes its recharge time. In this case, the hydraulic fluid contained in the plunger vessel, starts exiting, through inertia, through the openings, to the space between the plunger cap, the motor block, the outer case and the inner case.

We can therefore see that with one complete turn the crankshaft receives from the outside, both units complete, respectively, their compression time and their recharge time.

In this way, the torque that enters the device from outside the crankshaft instantly becomes amplified torque on the crankshaft at the outlet of the device.

This implies an improvement in the prior art since this invention only has pistons and plungers and a crankshaft as moving parts. Likewise, it does not have a fluid tank or inlet or outlet fluid hoses, and, by having a single shaft, a device of the invention can be attached to the rotating shaft, and one or several more devices can be attached thereto, to one other, exponentiating the torque that each one amplifies, achieving very high torque values in a simple manner.

The rotating shaft, which attaches to the device, may come from any type of motor, hydraulic turbine, machinery driven by wind power and even a mechanism driven by human force.

Scientific Support for the Functioning of the Proposed Invention
Tø The torque received by the invention from external energy.
Fø The linear force entering the invention, which is perpendicular to the tangent between the cam and the roller follower.
γ The turning radius of the shaft of the eccentric circular cams.
υ The maximum displacement of the roller follower and each plunger owing to the drive of the eccentric circular cam.
Fø_{N} The linear force that is a component of Fø and the normal line.
α The angle formed between Fø and the normal Line.
Q The quantity of mini plungers that forms the upper section of a plunger, which pressurise the fluid in a respective compression chamber, and which produce the mechanical work entering said compression chamber.
P The pressure exerted by the mini plunger set of a plunger at any point of the fluid in the respective compression chamber.
A The surface area of each piston.
∂ The surface area of each mini plunger.
Fₜ The linear force generated by the fluid in the piston.
C The displacement of each piston.
T₁ The torque that F₁ generates on the crankshaft.

The input torque Tø generates a linear force Fø at the cam-roller follower point of tangency. The magnitude of this force depends on the distance between the centre of the cam and the point of tangency between the cam and the roller follower. This distance varies between a minimum γ and a maximum υ+γ. By convention, we will use the maximum value, with which Fø acquires the value

$$F ∅ = \frac{T ∅}{υ + γ} ,$$

this value being the minimum value that Fø can acquire.

But it is the Fø_{N} normal component of the linear force Fø that displaces the roller follower, and its value is FøN=Fø (cosine α). The largest angle α observed in the design of the proposed invention is 16°. The cosine 16° is 0.95, and this will be the one that assigns the lowest value to Fø_{N}, that is, Fø_{N}=0.95 Fø.

This linear force Fø_{N} causes the mini plungers of the plunger Q, as a whole, to apply to the fluid in the respective compression chamber, pressure at each of its points, due to the action of Pascal's law.

Since the mechanical work of the set of the mini plungers Q and that of the piston are the same, we get:

$$( 0.95 F ∅ Q ) υ = ( {F}_{1} ) C$$

Then:

$${F}_{1} = \frac{( 0.95 F ∅ Q ) υ}{C} ,$$

which will be the linear force that will be applied to the surface of the piston. This force, acting through the respective connecting rod, with a C/2 lever arm, will produce the torque T₁=F₁ (C/2), on the crankshaft.

Replacing the value of F₁, we get:

$${T}_{1} = \frac{0.95 F ∅ Q υ}{C} \times \frac{C}{2} = \frac{0.475 F ∅ Q υ}{1}$$

$$Since F ∅ = \frac{T ∅}{υ + γ} , then , {T}_{1} = \frac{0.475 T ∅ Q υ}{υ + γ}$$

$${T}_{1} = \frac{0.475 Q υ}{υ + γ} \times T ∅$$

That is, the amplification factor that affects the torque Tø entering the device, to convert it into output T₁ is

$$\frac{0.475 Q υ}{υ + γ}$$

Note that the torque has been amplified, but that the mechanical work of the Q of mini plungers set of each plunger, 0.95 i FøQυ: and that of each piston F₁C, are the same.

Likewise, the volume of fluid displaced in its work by the Q of mini plungers set of each plunger Q∂υ, is equal to that displaced by each piston, that is, AC.

Scientific Support for the Exponentiality of the Proposed Invention

Assuming that we attach another unit of the invention to the outlet of the first unit, the following apply:
F_{ε} The linear force entering the second unit, which is perpendicular to the tangent between its cam and its roller follower.
F_{εN} The linear force that is the normal component of F_{S}

Q The quantity of mini plungers that forms the upper section of a plunger, which pressurise the fluid in the respective compression chamber, and which produce the mechanical work entering said compression chamber.
P The pressure that the set of mini plungers of a plunger exerts at any point of the fluid in the respective compression chamber.
∂ The surface area of each mini plunger.
F₂ The linear force that the fluid pressure generates in the piston.
A The surface area of each piston.
C The displacement of each piston.
T_{ε} The torque entering the second unit, that is, the same as the output of the first unit, T₁.
γ The turning radius of the shaft of the eccentric circular cams.
υ The maximum displacement of the roller follower and each plunger owing to the action of the eccentric circular cam.
Tø The torque received by the first unit from external energy.
T₂ The torque that F₂ generates on the crankshaft.

The second unit, attached to the outlet of the first unit, receives torque therefrom, generated by a linear force, which we will call Fₛ. This force causes its roller follower to move. We already know that the normal component of this force, Fₑ_{_{R}}=0.95 Fe is what causes the mini plungers Q to exert pressure on the fluid in the compression chamber, and that, as a result of Pascal's Law, this pressure manifests itself at every point of said compression chamber. We also know that the mechanical work of the Q of mini plungers as a set is equal to the mechanical work of the piston, that is: (0.95 FₑQ)υ=(F₂ C)

Then

$${F}_{2} = \frac{0.95 {F}_{ɛ} Q υ}{C}$$

The torque that this linear force F₂ transmits to the crankshaft of the second unit will be:

$${T}_{2} = {F}_{2} ( C / 2 )$$

$$Since , {F}_{2} = \frac{0.95 {F}_{ɛ} Q υ}{C} {F}_{ɛ} = \frac{{T}_{1}}{υ + γ}$$

$$Y , {T}_{1} = \frac{0.475 Q υ}{υ + γ} \times {T}_{∅} ,$$

replacing these values in T₂, we will get:

$${T}_{2} = \frac{0.95 {F}_{ɛ} Q υ}{C} \times ( C / 2 ) = 0.475 {F}_{ɛ} Q υ$$

$${T}_{2} = 0.475 [ \frac{{T}_{1}}{υ + γ} ] Q υ = 0.475 \frac{[ \frac{0.475 Q {υT}_{ɛ}}{υ + γ} ] Q υ}{υ + γ}$$

$${T}_{2} = \frac{{( 0.475 )}^{2} {Q}^{2} {υ}^{2} {T}_{∅}}{{( υ + γ )}^{2}} = {( \frac{0.475 Q υ}{υ + γ} )}^{2} \times {T}_{∅}$$

$${T}_{2} = {( \frac{0.475 Q υ}{υ + γ} )}^{2} \times {T}_{∅}$$

It is noted that by attaching a second unit to the outlet of the first unit, the amplification factor

$$\frac{0.47 Q υ}{υ + γ}$$

increases to the second power. We can infer that by attaching “n” units of the invention the factor will increase to the power “n”.

$${T}_{n} = {( \frac{0.475 Q υ}{υ + γ} )}^{n} \times {T}_{∅}$$

### BRIEF DESCRIPTION OF THE FIGURES

In order to easily identify the parts of the proposed invention, each one has been labelled with a number.

FIG. 1: Provides a view of the horizontal cross-section wherein the crankshaft (1), the eccentric circular cams (2), the bearings (3), the cylinder heads (5), the outer cases (6), the flanges of the cylinder head (7), the motor blocks (8), the inner cases (9), the compression chambers (10), the plungers (11), the plunger caps (12), the mini plungers (13), the openings in the cap (14), the plunger vessels (15), the bases of the plunger (16), the roller follower studs (17), the roller followers (18), the plunger rings (19), the pistons (20), the connecting rods (21), the piston rings (22), the mating flanges (23) and the anchor rods (24) of both units (4) are shown.

FIG. 2: Provides a view of two partial frontal vertical cross-sections, wherein A provides details of the location of the eccentric circular cam (2) and the plunger (11) at the end of the compression time in one unit (4). B provides details of the location of the piston (20) at the start of the compression time in one unit (4).

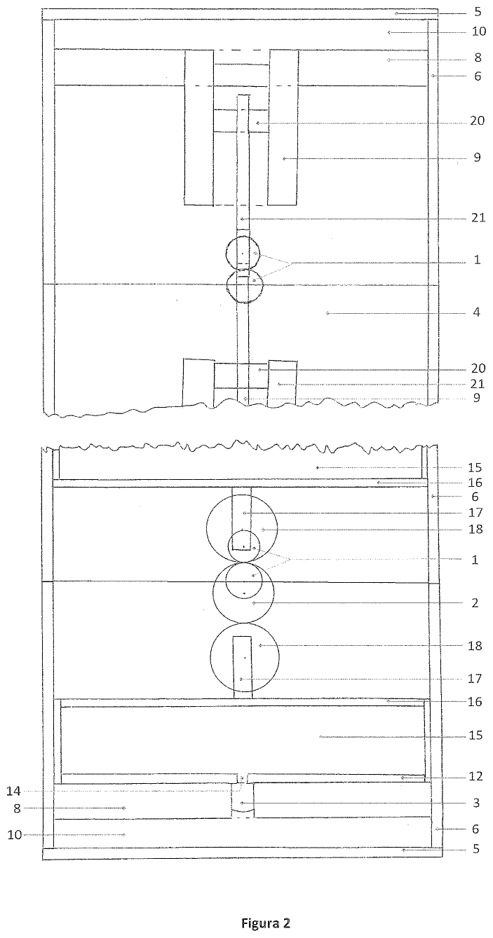

FIG. 3: Provides a profile view of the vertical cross-section, wherein the outer case (6), the lateral walls of the plunger (11), the plunger cap (12), the mini plungers (13), the openings in the cap (14), the inner case (9) and the piston (20) are shown.

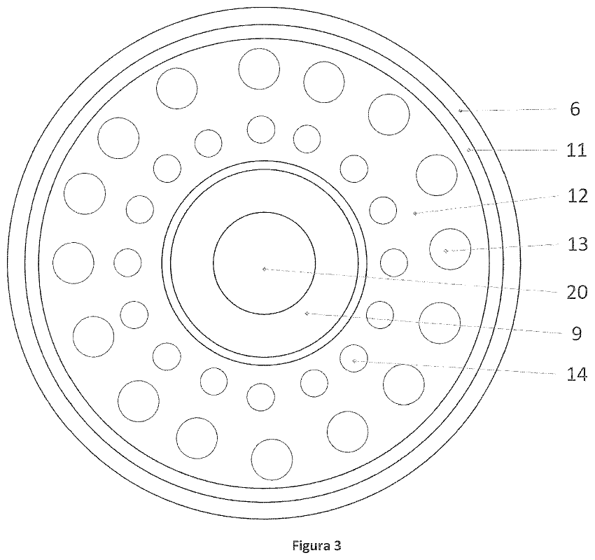

FIG. 4: Provides a view of the horizontal cross-section which details the location of the crankshaft (1), the plungers (11), and the pistons (20) at the start of the recharge time of one of the units (4).

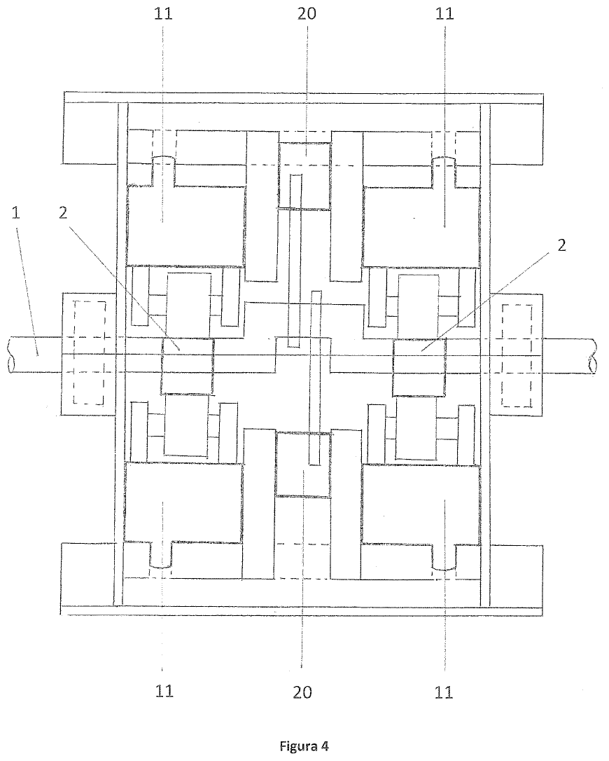

FIG. 5: Provides a view of the horizontal cross-section wherein the location of the crankshaft (1), the plungers (11) and the pistons (20) during the recharge time of one of the units (4) is shown.

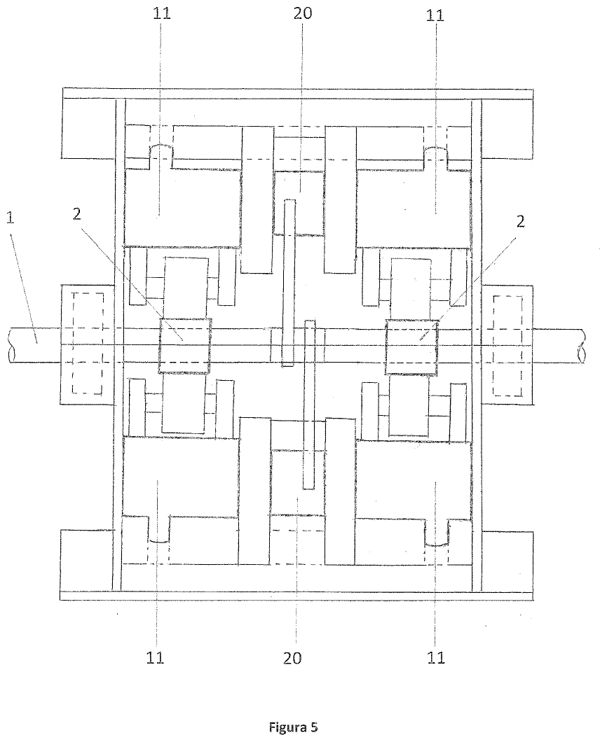

FIG. 6: Provides a view of the horizontal cross-section wherein the location of the crankshaft (1), the plungers (11) and the pistons (20) at the end of the recharge time of one of the units (4) is shown.

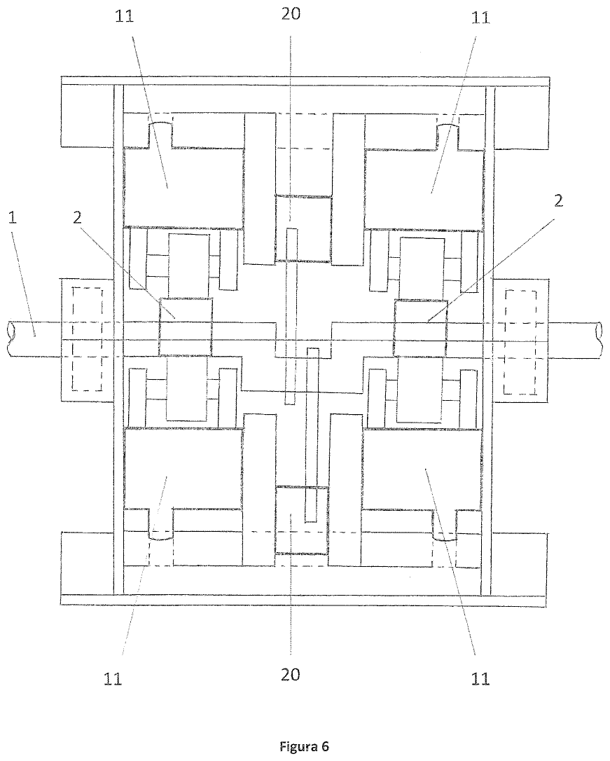

### PREFERRED EMBODIMENT OF THE INVENTION

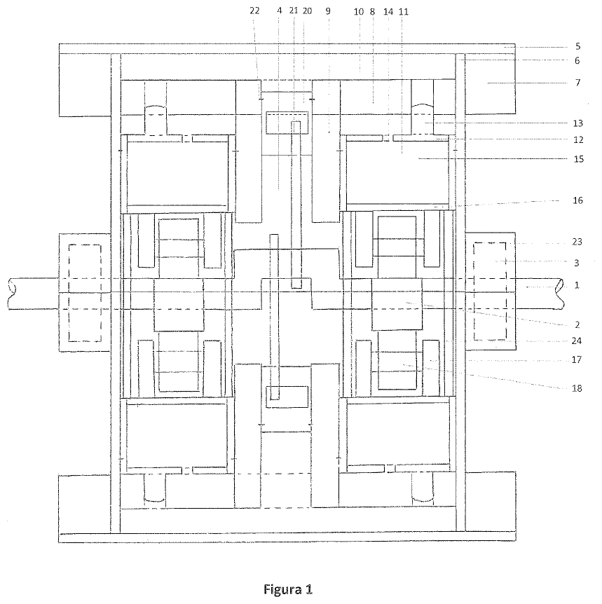

In the embodiment shown in FIG. 1, it can be seen that the invention has a crankshaft (1), which is the shaft that receives the force from the outside in the form of rotary movement, and that in addition, it receives the torque that the invention itself amplifies. Two eccentric circular cams (2) are fixed to the crankshaft (1), the perimetral area of the former forming tangency with surface of the latter. On either side of the crankshaft (1), the device has one unit (4), each one being opposite each other in a form of 180-degree V motor, each unit comprising:
A cylinder head (5), a metal cap that encases along with the outer case (6), metal cylinder, the other parts of the unit (4).
A cylinder head flange (7), a metal part which serves as reinforcement for the outer case (6). It is screwed and/or sealed to the outer surface of the outer case (6) at its end near to its cylinder head (5).
A motor block (8), a solid metal part, which is screwed and/or sealed to the inner surface of the outer case (6), and which contains orifices which serve as cylinders in which the mini plungers (13) operate, parts whose function is to generate pressure in the compression chambers (10).
An inner case (9), a metal cylinder, which is screwed and/or welded to the motor block (8) at its inner side and on whose inner surface the pistons work (20).
A compression chamber (10), a space that forms between the cylinder head (5), the end of the outer case (6) near to it, the end of the outer case (9) near to it and by the surface closest to the cylinder head (5) of the piston (20) and which is filled with hydraulic fluid.
A plunger cap (12), which is a metal disc at the end of the plunger (11) that contains the mini plungers (13), small solid metal pistons, which are introduced into the cylinders of the motor block (8) to generate pressure in the hydraulic fluid contained in the compression chamber (10) and openings (14) that serve to allow the hydraulic fluid in the plunger vessel (15) to enter/leave it in order to perform its sealing, lubrication and cooling work. It is screwed and/or sealed to the inner wall of the plunger (11).
A plunger base (16), a metal disc that is screwed and/or sealed to the inner surface of the plunger (11) at the opposite end to the plunger cap (12). On its outer section, two studs (17), metallic parts that are diametrically opposed, are welded, on each of which is placed a roller follower (18) which serves to linearly displace the plunger (11) owing to the action of the eccentric circular cams (2).
Two plunger rings (19) for pressure and lubrication functions that establish contact between the plunger (11) and the inner surface of the outer case (6) and the outer surface of the inner case (9) to maintain the hydraulic fluid pressure of the plunger vessel (15) on the surface of the motor block (8) closest to the plunger (11), as well as to clean the hydraulic fluid that adheres to the surfaces of the outer case (6) and the inner case (9).
A piston (20), a solid metal cylinder, which receives the pressure generated in the compression chamber (10) on its surface closest to its cylinder head (5) and which generates a linear force on it, which moves it away from its cylinder head (5). It moves inside the inner case (9) and makes contact with it through the piston rings (22) that are responsible for maintaining the pressure without any loss on the surface of the piston (20) and for cleaning the hydraulic fluid that adheres to the inner surface of the inner case (9).
A connecting rod (21), a metal part that joins the piston (20) with the crankshaft (1) and that transmits the linear force from the piston (20) thereto, converting it into torque on the crankshaft (1).
A mating flange (23), a cylindrical metal part that reinforces the outer case (6) and that is screwed and/or sealed to the outer surface of the outer case (6) at its end furthest from its cylinder head (5).

Between the furthest ends of their cylinder heads (5), the plungers (11) are attached to one another by rods (24), metal parts that hold them together so that they work as a desmodromic system so that the compression and recharge times work accurately.

Since the nature of the invention has been sufficiently described, as well as an example of a preferred embodiment, it is stated for the appropriate purposes, that the materials, shape, size and arrangement of the described parts may be modified, provided that this does not involve any alteration of the essential characteristics of the invention.

1. Machine that amplifies the torque of a rotating shaft characterised in that it comprises: at least one pair of identical units (4) on either side of a crankshaft (1); each unit (4) formed by an outer case (6) and an inner case (9) inside which a plunger (11) moves, a piston (20) that moves inside the inner case (9), a connecting rod (21) that transfers the amplified force of the piston (20) to convert it into torque for the crankshaft (1) that contains at least one elbow for the connecting rods (21) of the pair of units (4) and at least one cam (2), a compression chamber (10), whose walls are formed by a motor block (8), a cylinder head (5), the outer case (6) and the inner case (9), a cylinder head flange (7) that secures the cylinder head (5), a mating flange (23) that secures the pair of units (4) to each other, a roller follower (18) for each cam (2) and at least two rods (24) that attach together to the plungers (11) of the pair of units (4).

2. Machine that amplifies the torque of a rotating shaft according to claim 1, characterised in that the cam (2) is circular and eccentric with respect to the crankshaft (1) in such a way that one section of the surface of the cam which makes contact with the roller follower (18) is tangent to the surface of the crankshaft (1).

3. Machine that amplifies the torque of a rotating shaft according to claim 1, characterised in that its crankshaft (1) receives both external energy in the form of rotary movement and force amplified by the machine itself on its piston (20), which when transferred by the connecting rod (21) converts into amplified torque of the crankshaft (1).

4. Machine that amplifies the torque of a rotating shaft, according to claim 1, characterised in that the plunger (11) of one unit (4) is formed by lateral walls, a plunger cap (12), a plunger bottom (16) and a plunger vessel (15), the plunger cap (12) containing the exact quantity of mini plungers (13) for the mechanical work of these as a set to equal the mechanical work of the piston (20), both performed on the compression chamber (10).

5. Machine that amplifies the torque of a rotating shaft, according to claim 1, characterised in that the crankshaft (1) at its free end of power delivery, attaches to at least one machine identical to that of claim 1, so that the torque that is finally delivered has the value of the torque of the outer rotating shaft multiplied by the amplification factors of all of the machines identical to those of claim 1 attached to said rotating shaft.
